(19) United States
(12) Patent Application Publication
(10) Pub. No.: US 2025/0019796 A1
(43) Pub. Date: Jan. 16, 2025

(54) HIGH-THROUGHPUT PREPARATION METHOD OF (Sm,T)(Fe,M)12 ALLOY BASED ON DIFFUSION MULTIPLE

(71) Applicant: Zhejiang University, Hangzhou (CN)

(72) Inventors: Jiaying JIN, Hangzhou (CN); Mengfan BU, Hangzhou (CN); Yunfei WANG, Hangzhou (CN); Xu LI, Hangzhou (CN); Faxiang QIN, Hangzhou (CN); Mi YAN, Hangzhou (CN)

(21) Appl. No.: 18/901,050

(22) Filed: Sep. 30, 2024

(30) Foreign Application Priority Data
Oct. 24, 2023 (CN) 202311381494.8

(51) Int. Cl. C22C 1/02; B23K 15/00; C22C 28/00

(52) U.S. Cl. CPC C22C 1/02; B23K 15/0053; C22C 28/00

(57) ABSTRACT

A (Sm,T)(Fe,M)₁₂ alloy is provided, where Sm is samarium element; Fe is iron element; T is selected from the group consisting of Y, Gd, Zr, Nd, Pr, Ce and a combination thereof; and M is selected from the group consisting of Ti, Cr, Mn, Mo, Si, Al, Ga, Co, V and a combination thereof. A high-throughput method of preparing the (Sm,T)(Fe,M)₁₂ alloy based on a diffusion multiple is further provided, in which a can, a cover, and metal strips with desired sizes are prepared, and the metal strips are arranged and loaded in the can. Then the can is subjected to vacuum electron beam welding and hot isostatic pressing to obtain the diffusion multiple, which is cut into slices, and subjected to tube sealing and heat treatment to obtain the desired (Sm,T)(Fe,M)₁₂ alloy.

### CROSS-REFERENCE TO RELATED APPLICATIONS

This application claims the benefit of priority from Chinese Patent Application No. 202311381494.8, filed on Oct. 24, 2023. The content of the aforementioned application, including any intervening amendments thereto, is incorporated herein by reference in its entirety.

### TECHNICAL FIELD

This application relates to rare-earth permanent magnets, and more specifically to a high-throughput preparation method of (Sm,T)(Fe,M)₁₂ alloys based on a diffusion multiple.

### BACKGROUND

Up to now, samarium cobalt (SmCo) and neodymium iron boron (NdFeB) are widely used rare earth permanent magnetic materials, among which NdFeB permanent magnets are known as the “king of magnets” due to the high energy product. It has been reported that the maximum energy product (BH) max of sintered NdFeB magnets has approached the theoretical value, which is difficult to achieve a significant increase. Researchers have focused on two aspects to further develop permanent magnetic materials. On one hand, based on the idea of artificially constructing metamaterials, the hard magnetic phase with high coercivity and the soft magnetic phase with high saturation magnetization are composited at the nanoscale to prepare nanocomposite permanent magnets, thereby obtaining ultra-high (BH) max. However, the (BH) max of the experimentally-prepared bulk nanocomposites is still limited. The main reason lies in the difficulty in precise size control and uniform dispersion of hard and soft magnetic phases, and good orientation of hard magnetic phase grains at the same time, which is also called “engineering nightmare”. On the other hand, we continue to search for other magnetic compounds with better intrinsic properties. Due to the iron element and large c/a values of unit cell, ThMn₁₂-type (1:12-type) rare-earth ferromagnetic compounds firstly reported in 1981 attracted extensive attention from permanent magnet researchers, which are expected to possess both high saturation magnetization and high magneto-crystalline anisotropy field.

In addition, on the pathway developing high-performance rare earth permanent magnetic materials, the composition design tends to be diversified, with more complex multi-phase microstructure and complicated preparation method. If the traditional mode of “experience-guided experiment” is still followed, the research and development of new materials will be faced with a long period of time, large investment, and low efficiency. For example, the phase stability of (Sm,T)(Fe,M)₁₂ permanent magnetic materials can be improved through the elemental substitution, thereby improving the intrinsic properties. However, the above methods require continuous adjustment of experimental parameters in order to optimize the phase formation behavior and comprehensive magnetic properties. This traditional method of “experiment-theory-experiment” with a long experimental period and limited valid data, has become a key common problem to be solved in the research and development of novel rare-earth permanent magnetic materials. A high-throughput experimental method can effectively improve the experimental efficiency by preparing a large number of parallel samples in a short period through the preparation of diffusion multiple, combined with parallel characterization.

### SUMMARY

In view of the deficiencies of the prior art, this application provides a high-throughput method of preparing (Sm,T)(Fe,M)₁₂ alloys based on a diffusion multiple, comprising:
(a) preparing a can and a cover matched with the can; and machining a rectangular groove of 3a×2b×c, in millimeters, 10≥a≥3, 10≥b≥3, and c≥10;
(b) preparing 6 metal strips with a dimension of a×b×c; and grinding and polishing a surface of each of the 6 metal strips; wherein the 6 metal strips are made of Fe, Sm, T1, T2, M1, and M2, respectively; T1 and T2 are selected from the group consisting of Y, Gd, Zr, Nd, Pr, Ce, and an alloy thereof; M1 and M2 are selected from the group consisting of Ti, Cr, Mn, Mo, Si, Al, Ga, Co, V, and an alloy thereof; and a, b and c represents a length, a width and a height of each of the 6 metal strips, respectively;
(c) arranging the 6 metal strips after grind and polishing the surface of the each of the 6 metal strips into a cuboid structure of 3a×2b×c in sequence; assembling the cuboid structure into the rectangular groove; covering the cover; and performing vacuum electron beam welding on the can and to obtain a welded can; wherein a Sm metal strip and a Fe metal strip are located in a middle of first and second rows of the cuboid structure, respectively; a M1 metal strip and a M2 metal strip are located at left and right sides of the Fe metal strip, respectively; and a T1 metal strip and a T2 metal strip are located at left and right sides of the Sm metal strip, respectively;
(d) subjecting the welded can to hot isostatic pressing to obtain the diffusion multiple; and
(e) cutting the diffusion multiple into a plurality of slices in a height direction, sealing the plurality of slices in a tube; and performing diffusion heat treatment after sealing to obtain the (Sm,T)(Fe,M)₁₂ alloy based on the diffusion multiple.

In an embodiment, in step (a), the can is made of one selected from the group consisting of 304 stainless steel, pure iron, or Cr metal; and the cover is made of the same material as the can.

In an embodiment, in step (b), the surface of each of the 6 metal strips is ground and polished by sandpaper sanding and machine polishing.

In an embodiment, in step (c), a vacuum degree of the vacuum electron beam welding is 5×10⁻⁵-5×10⁻⁴ Pa, and a width of a weld seam is 0.5-1.5 mm.

In an embodiment, in step (d), the hot isostatic pressure is performed at 650-950° C. and 50-200 MPa for 2-5 h.

In an embodiment, in step (e), the sealing is performed in argon atmosphere of 0.03-0.06 MPa.

In an embodiment, in step (e), the diffusion heat treatment is performed at 800-1300° C. for 2-30 days; and a cooling method after the diffusion heat treatment is quenching.

In an embodiment, in step (e), in the (Sm,T)(Fe,M)₁₂ alloy, Sm is samarium element; Fe is iron element; T is at least one selected from the group consisting of Y, Gd, Zr, Nd, Pr, and Ce; and M is at least one selected from the group consisting of Ti, Cr, Mn, Mo, Si, Al, Ga, Co, and V.

This application also provides the (Sm,T)(Fe,M)₁₂ alloy prepared according to above high throughput method. In the (Sm,T)(Fe,M)₁₂ alloy, wherein Sm is samarium element; Fe is iron element; T is at least one selected from the group consisting of Y, Gd, Zr, Nd, Pr, and Ce; and M is at least one selected from the group consisting of Ti, Cr, Mn, Mo, Si, Al, Ga, Co, and V.

Compared to the prior art, this application has the following beneficial effects.

(1) This application investigates the effects of different elemental substitutions on the phase formation behavior and phase stability of the SmFe₁₂-based phase and the changes in the intrinsic magnetic properties of the (Sm,T)(Fe,M)₁₂ alloys by preparing diffusion multiple with different compositions, which provides guidance for studying the 1:12-type permanent magnetic materials.

(2) This application explores different critical formation temperatures of (Sm,T)(Fe,M)₁₂ alloys, intermediate phases generated in the process, and the phase relation of intermediate phases with (Sm,T)(Fe,M)₁₂ alloys by different heat-treatment temperatures and times, so as to modulate the formation kinetics and improve the purity of the prepared (Sm,T)(Fe,M)₁₂ alloys.

(3) This application adopts a high-throughput experimental method to overcome the shortcomings of traditional trial-and-error method in research and development of new permanent magnetic materials, so a large amount of data can be obtained through a single experiment. A large number of parallel samples can be obtained in a short time, so as to carry out demonstrative preparation and analytical validation of diffusion multiple samples through parallel characterization. It also enables the establishment of a relevant database and provides reference for the subsequent research.

### BRIEF DESCRIPTION OF THE DRAWINGS

FIG. 1 schematically shows an arrangement of a diffusion multiple according to an embodiment of the present disclosure; and

FIG. 2 is a schematic diagram of a combination of a can and a cover according to an embodiment of the present disclosure.

### DETAILED DESCRIPTION OF EMBODIMENTS

The present disclosure is further described below in combination with embodiments. Accordingly, the following detailed description is merely illustrative, and is not intended to limit the scope of the disclosure. The technical features of the various embodiments can be combined without conflict with each other.

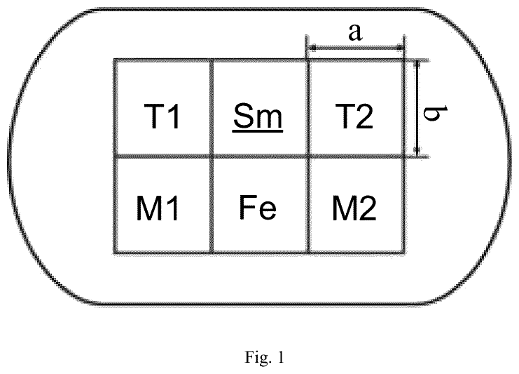

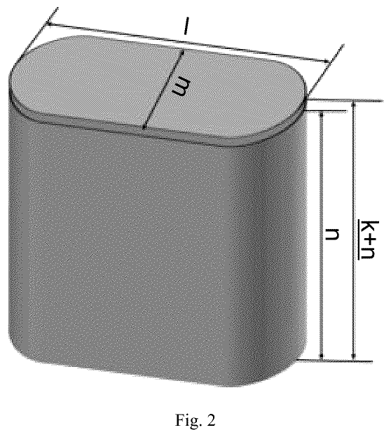

As shown in FIG. 1, 6 metal strips with dimensions of a×b×c are arranged in a runway-shaped can, and a, b and c represents a length, a width and a height of each of the 6 metal strips, respectively. As shown in FIG. 2, cross sections of a can and a cover are runway-shaped. The can has a size of 1×m×n, and the cover has a size of 1×m×k. l represents a length of the can and the cover, m represents a width of the can and the cover, n represents a height of the can, and k represents a height of the cover.

### Example 1

(1) A runway-shaped can with dimensions of 30×18×45 mm³ and a cover with dimensions of 30×18×1 mm³ were prepared. A rectangular groove of 21×14×40 mm³ was machined in the can. The can and the cover were each made of 304 stainless steel.

(2) Sm, Y, Zr, Fe, V and Ti metal strips with dimensions of 7×7×40 mm³ were prepared. The surfaces of the metal strips were performed with sandpaper grinding and polishing treatment by polishing machine.

(3) The metal strips were assembled into the rectangular groove followed by covering the cover and carrying out vacuum electron beam welding at 5×10⁻⁴ Pa, and the width of the weld seam was 0.5 mm. The Sm metal strip and the Fe metal strip were respectively located in the middle of the first and second rows of the rectangular groove. The V metal strip and the Ti metal strip were respectively located on the left and right sides of the Fe metal strip. The Y metal strip and the Zr metal strip were respectively located on the left and right sides of the Sm metal strip.

(4) The welded can was performed with heat isostatic pressing at 750° C. and 100 MPa for 4 h to obtain the diffusion multiple.

(5) The diffusion multiple was cut into 8 slices parallel to the runway-shaped surface, and the 8 slices were separately sealed into the tubes at 0.04 MPa argon atmosphere followed by carrying out the diffusion heat treatment at 900° C., 1000° C., 1100° C., or 1200° C. for 15 and 30 days, respectively, and quenching cooling to obtain the (Sm,Y,Zr)(Fe,V,Ti)₁₂-phase alloy.

### Example 2

(1) A runway-shaped can with dimensions of 32×20×51 mm³ and a cover with dimensions of 32×20×1 mm³ were prepared. A rectangular groove of 24×16×45 mm³ was machined in the can. The can and the cover were each made of 304 stainless steel.

(2) Fe, Sm, Nd, Gd, Co and Ti metal strips with dimensions of 8×8×45 mm³. The surfaces of the metal strips were performed with sandpaper grinding and polishing treatment by polishing machine.

(3) The metal strips were assembled into the rectangular groove followed by covering the cover and carrying out vacuum electron beam welding at 5×10⁻⁵ Pa, and the width of the weld seam was 1.5 mm. The Sm metal strip and the Fe metal strip were respectively located in the middle of the first and second rows of the rectangular groove. The Co metal strip and the Ti metal strip were respectively located on the left and right sides of the Fe metal strip. The Nd metal strip and the Gd metal strip were respectively located on the left and right sides of the Sm metal strip.

(4) The welded can was performed with heat isostatic pressing at 650° C. and 50 MPa for 2 h to obtain the diffusion multiple.

(5) The diffusion multiple was cut into 10 slices parallel to the runway-shaped surface, and the 10 slices were separately sealed into the tubes at 0.06 MPa argon atmosphere followed by carrying out the diffusion heat treatment at 900° C., 950° C., 1000° C., 1050° C., or 1100° C. for 20 and 30 days, respectively, and quenching cooling to obtain the (Sm,Nd,Gd)(Fe,Co,Ti)₁₂-phase alloy.

### Example 3

(1) A runway-shaped can with dimensions of 28×20×51 mm³ and a cover with dimensions of 28×20×1 mm³ were prepared. A rectangular groove of 21×16×40 mm³ was machined in the can. The can and the cover were each made of 304 stainless steel.

(2) Fe, Sm, V, Gd, Mn and Ce metal strips with dimensions of 7×8×40 mm³. The surfaces of the metal strips were performed with sandpaper grinding and polishing treatment by polishing machine.

(3) The metal strips were assembled into the rectangular groove followed by covering the cover and carrying out vacuum electron beam welding at 5×10⁻⁵ Pa, and the width of the weld seam was 1.5 mm. The Sm metal strip and the Fe metal strip were respectively located in the middle of the first and second rows of the rectangular groove. The V metal strip and the Mn metal strip were respectively located on the left and right sides of the Fe metal strip. The Gd metal strip and the Ce metal strip were respectively located on the left and right sides of the Sm metal strip.

(4) The welded can was performed with heat isostatic pressing at 650° C. and 50 MPa for 2 h to obtain the diffusion multiple.

(5) The diffusion multiple was cut into 10 slices parallel to the runway-shaped surface, and the 10 slices were separately sealed into the tubes at 0.06 MPa argon atmosphere followed by carrying out the diffusion heat treatment at 900° C., 950° C., 1000° C., 1050° C., or 1100° C. for 20 and 30 days, respectively, and quenching cooling to obtain the (Sm,Ce,Gd)(Fe,Mn,V)₁₂-phase alloy.

### Example 4

(1) A runway-shaped can with dimensions of 32×20×51 mm³ and a cover with dimensions of 32×20×1 mm³ were prepared. A rectangular groove of 18×12×45 mm³ was machined in the can. The can and the cover were each made of 304 stainless steel.

(2) Fe, Sm, Nd, Y, Cr and Mo metal strips with dimensions of 6×6×45 mm³. The surfaces of the metal strips were performed with sandpaper grinding and polishing treatment by polishing machine.

(3) The metal strips were assembled into the rectangular groove followed by covering the cover and carrying out vacuum electron beam welding at 1×10⁻⁵ Pa, and the width of the weld seam was 1.5 mm. The Sm metal strip and the Fe metal strip were respectively located in the middle of the first and second rows of the rectangular groove. The Cr metal strip and the Mo metal strip were respectively located on the left and right sides of the Fe metal strip. The Nd metal strip and the Y metal strip were respectively located on the left and right sides of the Sm metal strip.

(4) The welded can was performed with heat isostatic pressing at 700° C. and 65 MPa for 5 h to obtain the diffusion multiple.

(5) The diffusion multiple was cut into 10 slices parallel to the runway-shaped surface, and the 10 slices were separately sealed into the tubes at 0.06 MPa argon atmosphere followed by carrying out the diffusion heat treatment at 950° C., 980° C., 1010° C., 1040° C., or 1070° C. for 15 and 20 days, respectively, and quenching cooling to obtain the (Sm,Nd,Y)(Fe,Cr,Mo)₁₂-phase alloys.

### Example 5

(1) A runway-shaped can with dimensions of 32×20×51 mm³ and a cover with dimensions of 32×20×1 mm³ were prepared. A rectangular groove of 24×16×45 mm³ was machined in the can. The can and the cover were each made of 304 stainless steel.

(2) Fe, Sm, NdPr (atomic ratio of 8:2), Gd, SiGa (atomic ratio of 2:8) and SiAl (atomic ratio of 1:1) metal strips with dimensions of 8×8×45 mm³. The surfaces of the metal strips were performed with sandpaper grinding and polishing treatment by polishing machine.

(3) The metal strips were assembled into the rectangular groove followed by covering the cover and carrying out vacuum electron beam welding at 3×10⁻⁵ Pa, and the width of the weld seam was 1.3 mm. The Sm metal strip and the Fe metal strip were respectively located in the middle of the first and second rows of the rectangular groove. The SiAl metal strip and the SiGa metal strip were respectively located on the left and right sides of the Fe metal strip. The NdPr metal strip and the Gd metal strip were respectively located on the left and right sides of the Sm metal strip.

(4) The welded can was performed with heat isostatic pressing at 800° C. and 85 MPa for 2 h to obtain the diffusion multiple.

(5) The diffusion multiple was cut into 9 slices parallel to the runway-shaped surface, and the 9 slices were separately sealed into the tubes at 0.06 MPa argon atmosphere followed by carrying out the diffusion heat treatment at 900° C., 920° C., 940° C., 960° C., or 980° C. for 10 and 20 days, respectively, and quenching cooling to obtain the (Sm,Nd,Pr,Gd)(Fe,Al,Ga,Si)₁₂-phase alloy.

### Comparative Example 1

(1) A runway-shaped can with dimensions of 32×20×51 mm³ and a cover with dimensions of 32×20×1 mm³ were prepared. A rectangular groove of 24×16×45 mm³ was machined in the can. The can and the cover were each made of 304 stainless steel.

(2) Fe, Sm, Nd, Gd, Co and Ti metal strips with dimensions of 8×8×45 mm³. The surfaces of the metal strips were performed with sandpaper grinding and polishing treatment by polishing machine.

(3) The metal strips were assembled into the rectangular groove followed by covering the cover and carrying out vacuum electron beam welding at 5×10⁻⁵ Pa, and the width of the weld seam was 1.5 mm. The Sm metal strip and the Fe metal strip were respectively located in the middle of the first and second rows of the rectangular groove. The Co metal strip and the Ti metal strip were respectively located on the left and right sides of the Sm metal strip. The Nd metal strip and the Gd metal strip were respectively located on the left and right sides of the Fe metal strip.

(4) The welded can was performed with heat isostatic pressing at 650° C. and 50 MPa for 2 h to obtain the diffusion multiple.

(5) The diffusion multiple was cut into 10 slices parallel to the runway-shaped surface, and the 10 slices were separately sealed into the tubes at 0.06 MPa argon atmosphere followed by carrying out the diffusion heat treatment at 900° C., 950° C., 1000° C., 1050° C., or 1100° C. for 20 and 30 days, respectively, and quenching cooling. Due to a change in the arrangement positions of the metal strips, Nd and Gd fail to replace the Sm element, Co and Ti fail to replace the Fe element, resulting in a decrease in the formation energy of the SmFe₁₂-based alloy. The (Sm,T)(Fe,M)₁₂ alloy could not be obtained.

### Comparative Example 2

(1) A runway-shaped can with dimensions of 32×20×51 mm³ and a cover with dimensions of 32×20×1 mm³ were prepared. A rectangular groove of 24×16×45 mm³ was machined in the can. The can and the cover were each made of 304 stainless steel.

(2) Fe, Sm, Nd, Gd, Co and Ti metal strips with dimensions of 8×8×45 mm³. The surfaces of the metal strips were performed with sandpaper grinding and polishing treatment by polishing machine.

(3) The metal strips were assembled into the rectangular groove followed by covering the cover and carrying out vacuum electron beam welding at 5×10⁻⁵ Pa, and the width of the weld seam was 1.5 mm. The Sm metal strip and the Fe metal strip were respectively located in the middle of the first and second rows of the rectangular groove. The Co metal strip and the Ti metal strip were respectively located on the left and right sides of the Fe metal strip. The Nd metal strip and the Gd metal strip were respectively located on the left and right sides of the Sm metal strip.

(4) The welded can was performed with heat isostatic pressing at 650° C. and 45 MPa for 2 h to obtain the diffusion multiple.

(5) The diffusion multiple was cut into 10 slices parallel to the runway-shaped surface, and the 10 slices were separately sealed into the tubes at 0.06 MPa argon atmosphere followed by carrying out the diffusion heat treatment at 900° C., 950° C., 1000° C., 1050° C., or 1100° C. for 20 and 30 days, respectively, and quenching cooling. Because the heat isostatic pressure was too low to form a tightly bonded interface, the (Sm,T)(Fe,M)₁₂ alloy could not be obtained.

Only a very small amount of SmFe₁₂ phase was formed at the binary interface of Sm and Fe under the delicately controlled conditions, indicating the formation of undoped SmFe₁₂ phase was difficult. In contrast, a large amount of (Sm, T) (Fe,M) 12 phase was obtained at the interface of Sm, Fe, and M, indicating that M could reduce the formation energy of the 1:12 phase and stabilize the structure. The effect of Ti was the most significant. However, the addition of Ti also significantly reduced the magnetic properties. When M was Co, the saturation magnetization and the Curie temperature of the 1:12 phase increased significantly. Only a small amount of 1:12 phase was formed at the interface of Sm, Fe, and T. In contrast, a large amount of 1:12 phase with different substitution ratios appeared at the quaternary interface of Sm, Fe, M, and T, which ensured the stability of the phase structure while minimizing the loss of magnetic properties.

Described above are merely some embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A method of preparing a (Sm,T)(Fe,M)₁₂ alloy based on a diffusion multiple, comprising:
(a) preparing a can and a cover matched with the can; and machining a rectangular groove with a size of 3a×2b×c in the can, wherein 10 mm≥a≥3 mm, 10 mm≥b≥3 mm, and c≥10 mm;
(b) preparing 6 metal strips each with a size of a×b×c, and grinding and polishing surfaces of the 6 metal strips; wherein the 6 metal strips are made of Fe, Sm, T1, T2, M1, and M2, respectively; T1 and T2 are independently selected from the group consisting of Y, Gd, Zr, Nd, Pr, Ce, and a combination thereof; M1 and M2 are independently selected from the group consisting of Ti, Cr, Mn, Mo, Si, Al, Ga, Co, V, and a combination thereof; and a, b and c represent length, width and height of each of the 6 metal strips, respectively;
(c) arranging the 6 metal strips in sequence to form a cuboid structure of 3a×2b×c, wherein a Sm metal strip is located at a middle of a first row of the cuboid structure, and a Fe metal strip is located at a middle of a second row of the cuboid structure, a M1 metal strip and a M2 metal strip are located at two sides of the Fe metal strip, respectively, and a T1 metal strip and a T2 metal strip are located at two sides of the Sm metal strip, respectively; loading the cuboid structure into the rectangular groove; sealing the can with the cover; and performing vacuum electron beam welding on the can to obtain a welded can;
(d) subjecting the welded can to hot isostatic pressing to obtain the diffusion multiple; and
(e) cutting the diffusion multiple into a plurality of slices in a height direction followed by tube sealing and diffusion heat treatment to obtain the (Sm,T)(Fe,M)₁₂ alloy.

2. The method of claim 1, wherein in step (a), the can is made of stainless steel, pure iron, or Cr metal; and the cover is made of the same material as the can.

3. The method of claim 1, wherein in step (b), the surfaces of the 6 metal strips are ground with sandpaper and polished by a polishing machine.

4. The method of claim 1, wherein in step (c), a vacuum degree of the vacuum electron beam welding is 5×10⁻⁵-5×10⁻⁴ Pa, and a weld width is 0.5-1.5 mm.

5. The method of claim 1, wherein in step (d), the hot isostatic pressing is performed at 650-950° C. and 50-200 MPa for 2-5 h.

6. The method of claim 1, wherein in step (e), the tube sealing is performed with an argon atmosphere of 0.03-0.06 MPa.

7. The method of claim 1, wherein in step (e), the diffusion heat treatment is performed at 800-1300° C. for 2-30 days; and
the method further comprises:
cooling a product obtained from the diffusion heat treatment by quenching.

8. The method of claim 1, wherein in the (Sm,T)(Fe,M)₁₂ alloy, Sm is samarium element; Fe is iron element; T is selected from the group consisting of Y, Gd, Zr, Nd, Pr, Ce and a combination thereof; and M is selected from the group consisting of Ti, Cr, Mn, Mo, Si, Al, Ga, Co, V and a combination thereof.

9. A (Sm,T)(Fe,M)₁₂ alloy prepared by the method of claim 1, wherein Sm is samarium element; Fe is iron element; T is selected from the group consisting of Y, Gd, Zr, Nd, Pr, Ce and a combination thereof; and M is selected from the group consisting of Ti, Cr, Mn, Mo, Si, Al, Ga, Co, V and a combination thereof.
